(19) United States
(12) Patent Application Publication
(10) Pub. No.: US 2017/0175750 A1
(43) Pub. Date: Jun. 22, 2017

(54) METHOD AND SYSTEM FOR VARYING TIP CLEARANCE GAP USING AN ACTUATED SHROUD

(71) Applicant: General Electric Company, Schenectady, NY (US)

(72) Inventor: Kevin Randall McManus, Liberty Township, OH (US)

(21) Appl. No.: 14/978,908

(22) Filed: Dec. 22, 2015

(51) Int. Cl. F04D 27/00; F02C 3/06; F04D 29/08; F04D 29/32; F04D 29/52; F04D 29/54; F02K 3/06; F04D 19/02

(52) U.S. Cl. CPC F04D 27/002; F02K 3/06; F02C 3/06; F04D 19/02; F04D 29/324; F04D 29/526; F04D 29/542; F04D 29/083; F05D 2220/323; F05D 2240/11; F05D 2240/35; F05D 2270/58

(57) ABSTRACT

An actuated shroud system configured to control tip clearances in a rotatable machine is provided. The system includes a rotor including a plurality of blades. Each of the plurality of blades includes a blade tip, and each blade tip includes a radially outer tip surface angled in the radial direction. The system also includes a shroud circumscribing the plurality of blades and including a radially inner surface angled complementarily to the radially outer tip surface of the blade tip. The radially inner surface and the radially outer tip surface define a tip clearance gap therebetween. The system further includes a shroud actuator operably coupled to the shroud, the shroud actuator configured to translate the shroud in at least one of an axial direction and the radial direction such that the tip clearance gap is variable based on a position of the shroud actuator.

### BACKGROUND

The field of the disclosure relates generally to gas turbine engines and, more particularly, to a method and system for varying blade tip clearance by actuating a shroud.

Many known gas turbine engines have a plurality of rotating systems therein, such as fans, turbines, and compressors, encased within a cylindrical casing or “shroud.” These rotating systems typically include one or more rows of rotating blades. A gap necessarily exists between a tip of the rotating blades and the shroud, to ensure that the blade tips do not contact the shroud during operation of the rotating system. However, air driven through the rotating system leaks through the tip clearance gap and contributes to decreased engine performance, for example, due to pressure loss and a reduction in blade loading.

It is desirable to minimize this clearance gap while maintaining a safe and/or optimal distance between the blade tip and the shroud. The blade tip may shift towards the shroud due to thermal expansion of the blades during high-throttle conditions. In order to prevent such expansion from causing the blade tip to contact the shroud, the shroud is typically designed as a static component configured to maintain a minimum safety or performance threshold clearance gap to accommodate for “worst-case” temperature conditions (e.g., during take-off or other high-throttle conditions). In addition, in at least some known systems, a cooling bleed air flow is directed toward the blade tip to reduce the thermal expansion, but cooling air takes time to affect the blades. In lower temperature conditions, the tip clearance gap is larger than needed, which reduces engine efficiency.

### BRIEF DESCRIPTION

In one aspect, an actuated shroud system configured to control tip clearances in a rotatable machine having blade members with a tip angled in a radial direction is provided. The system includes a rotor includes a plurality of blade members extending radially outwardly from a rotor disk. Each blade member of the plurality of blade members includes a blade tip at a radially outer extent of the blade member, and each blade tip includes a radially outer tip surface angled in the radial direction. The system also includes a shroud circumscribing the plurality of blade members. The shroud includes a radially inner surface angled complementarily to the radially outer tip surface of the plurality of blade members. The radially inner surface and the radially outer tip surface define a tip clearance gap therebetween. The system further includes a shroud actuator operably coupled to the shroud. The shroud actuator is configured to translate the shroud in at least one of an axial direction and the radial direction such that the tip clearance gap is variable based on a position of the shroud actuator.

In another aspect, a method of varying a tip clearance gap using an actuated shroud is provided. The method includes operably coupling a shroud actuator to a shroud, the shroud circumscribing a plurality of blade members of a rotor. Each blade member of the plurality of blade members includes a blade tip at a radially outer extent of the blade member, and each of the blade tips includes a radially outer tip surface angled in the radial direction. The shroud includes a radially inner surface angled complementarily to the radially outer tip surface of the plurality of blade members. The radially inner surface and the radially outer tip surface define a tip clearance gap therebetween. The method also includes varying a position of the shroud actuator, the varying translating the shroud in at least one of an axial direction and the radial direction such that the tip clearance gap is variable based on a position of the shroud actuator.

In yet another aspect, a turbofan engine is provided. The turbofan engine includes a core engine including a multistage compressor, a fan powered by a power turbine driven by gas generated in the core engine, a fan bypass duct at least partially surrounding the core engine and the fan, and an actuated shroud system configured to control tip clearances in the compressor. The actuated shroud system includes a rotor including a plurality of blade members extending radially outwardly from a rotor disk. Each blade member of the plurality of blade members includes a blade tip at a radially outer extent of the blade member, and each blade tip includes a radially outer tip surface angled in the radial direction. The actuated shroud system also includes a shroud circumscribing the plurality of blade members. The shroud includes a radially inner surface angled complementarily to the radially outer tip surface of the plurality of blade members. The radially inner surface and the radially outer tip surface define a tip clearance gap therebetween. The actuated shroud system further includes a shroud actuator operably coupled to the shroud. The shroud actuator is configured to translate the shroud in at least one of an axial direction and the radial direction such that the tip clearance gap is variable based on a position of the shroud actuator.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic cross-sectional view of a gas turbine engine in accordance with an exemplary embodiment of the present disclosure, including an actuated shroud system.

FIG. 2 is a view of a cross-section of a high-pressure turbine including the actuated shroud system shown in FIG. 1.

FIG. 3 is a view of a shroud at least partially surrounding the high-pressure turbine shown in FIG. 2.

FIG. 4 is a schematic block diagram of an example embodiment of a controller of the actuated shroud system shown in FIGS. 1 and 2.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Embodiments of the actuated shroud systems described herein provide a cost-effective method for minimizing a tip clearance gap between a blade tip and shroud by actuating the shroud. In one embodiment, the actuated shroud system includes a shroud actuator, including a cam and lever system configured to vary the position of the shroud according to a particular path. Minimizing the tip clearance gap while maintaining a predetermined threshold distance between the blade tip and shroud may improve engine efficiency. Moreover, as the actuated shroud system replaces a static shroud and permits radial translation of the shroud to accommodate varying tip clearance gaps, the actuated shroud system may facilitate design of smaller, lighter core engines.

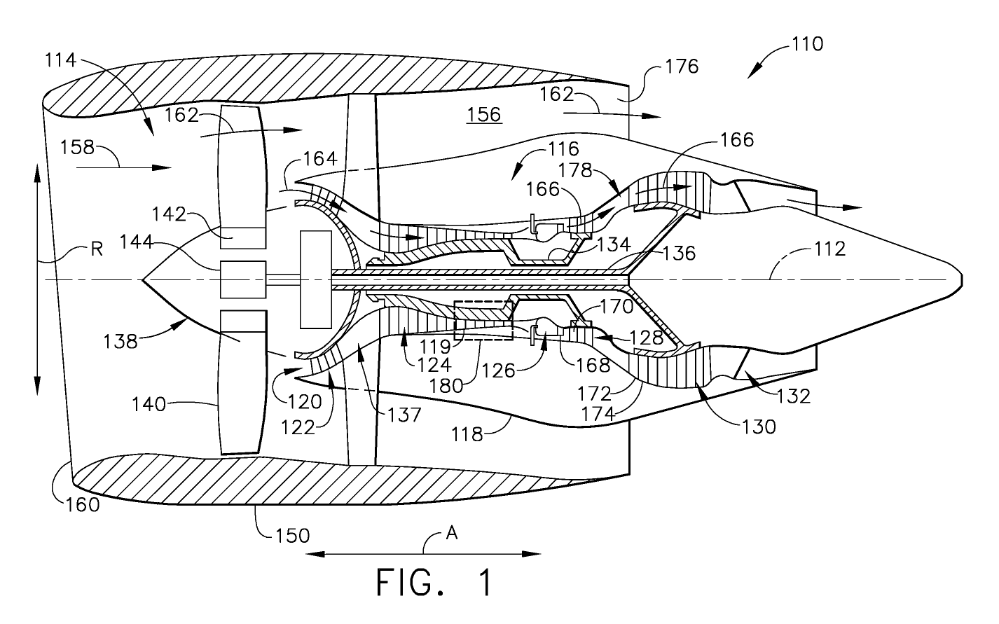

FIG. 1 is a schematic cross-sectional view of a gas turbine engine 100 in accordance with an exemplary embodiment of the present disclosure. In the example embodiment, gas turbine engine 100 is embodied in a high-bypass turbofan jet engine. As shown in FIG. 1, turbofan engine 100 defines an axial direction A (extending parallel to a longitudinal centerline 112 provided for reference) and a radial direction R. In general, turbofan 100 includes a fan assembly 114 and a core engine 116 disposed downstream from fan assembly 114.

In the example embodiment, core engine 116 includes an approximately tubular outer casing 118 that defines an annular inlet 120. A shroud 119 defines an inner surface or boundary of outer casing 118. Outer casing 118 encases, in serial flow relationship, a compressor section including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. A high pressure (HP) shaft or spool 134 drivingly connects HP turbine 128 to HP compressor 124. A low pressure (LP) shaft or spool 136 drivingly connects LP turbine 130 to LP compressor 122. The compressor section, combustion section 126, the turbine section, and nozzle section 132 together define a core air flowpath 137.

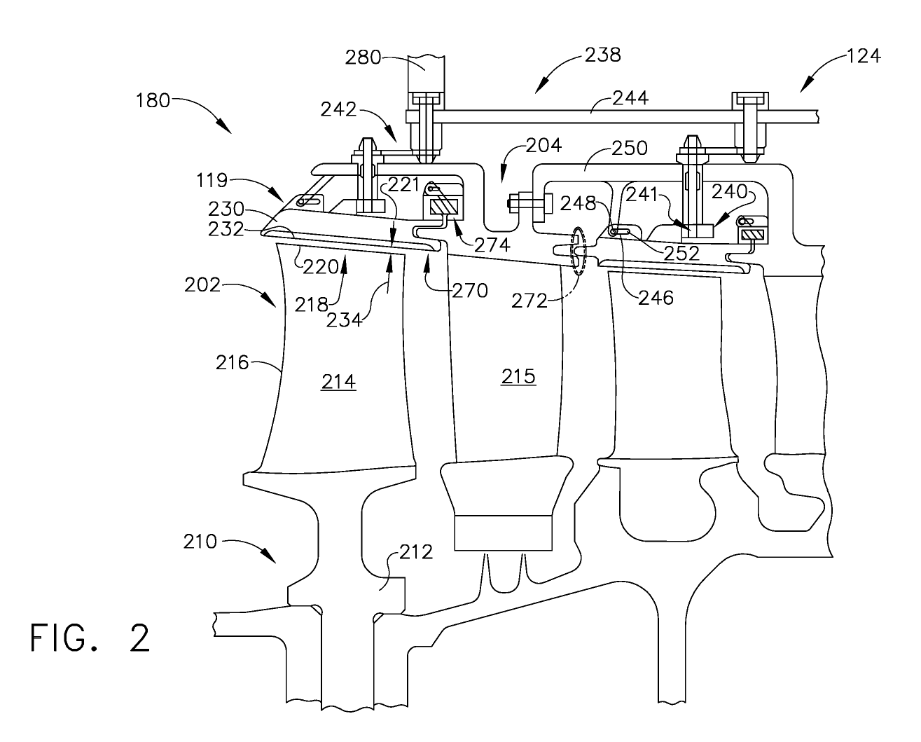

During operation of turbofan engine 100, a volume of air 158 enters turbofan engine 100 through an associated inlet 160 of fan assembly 114, which includes fan 138. As volume of air 158 passes across a plurality of fan blades 140 of fan 138, a first portion 162 of volume of air 158 is directed or routed into a bypass airflow passage 156 (between core engine 116 and an annular nacelle 150) and a second portion 164 of volume of air 158 is directed or routed into core air flowpath 137, or more specifically into LP compressor 122. A ratio between first portion 162 and second portion 164 is commonly referred to as a bypass ratio. The pressure of second portion 164 is then increased as it is routed through high pressure (HP) compressor 124 and into combustion section 126, where it is mixed with fuel and burned to provide combustion gases 166. A clearance gap 234 (shown in FIG. 2) exists between a tip of compressor rotor blades 214 (also shown in FIG. 2) and shroud 119, through which a portion of gases 164 leaks, resulting pressure loss and a reduction of the efficiency of HP compressor 124. Turbofan engine 100 includes an actuated shroud system 180 configured to vary clearance gap 234 by varying a position of at least a portion of shroud 119.

Combustion gases 166 are routed through HP turbine 128 where a portion of thermal and/or kinetic energy from combustion gases 166 is extracted via sequential stages of HP turbine stator vanes 168 that are coupled to outer casing 118 and HP turbine rotor blades 170 that are coupled to HP shaft or spool 134, thus causing HP shaft or spool 134 to rotate, which then drives a rotation of HP compressor 124. Combustion gases 166 are then routed through LP turbine 130 where a second portion of thermal and kinetic energy is extracted from combustion gases 166 via sequential stages of LP turbine stator vanes 172 that are coupled to outer casing 118 and LP turbine rotor blades 174 that are coupled to LP shaft or spool 136, which drives a rotation of LP shaft or spool 136 and LP compressor 122 and/or rotation of fan 138.

Combustion gases 166 are subsequently routed through jet exhaust nozzle section 132 of core engine 116 to provide propulsive thrust. Simultaneously, the pressure of first portion 162 is substantially increased as first portion 162 is routed through bypass airflow passage 156 before it is exhausted from a fan nozzle exhaust section 176 of turbofan engine 100, also providing propulsive thrust. HP turbine 128, LP turbine 130, and jet exhaust nozzle section 132 at least partially define a hot gas path 178 for routing combustion gases 166 through core engine 116.

Turbofan engine 100 is depicted in FIG. 1 by way of example only, and that in other exemplary embodiments, turbofan engine 100 may have any other suitable configuration including for example, a turboprop engine.

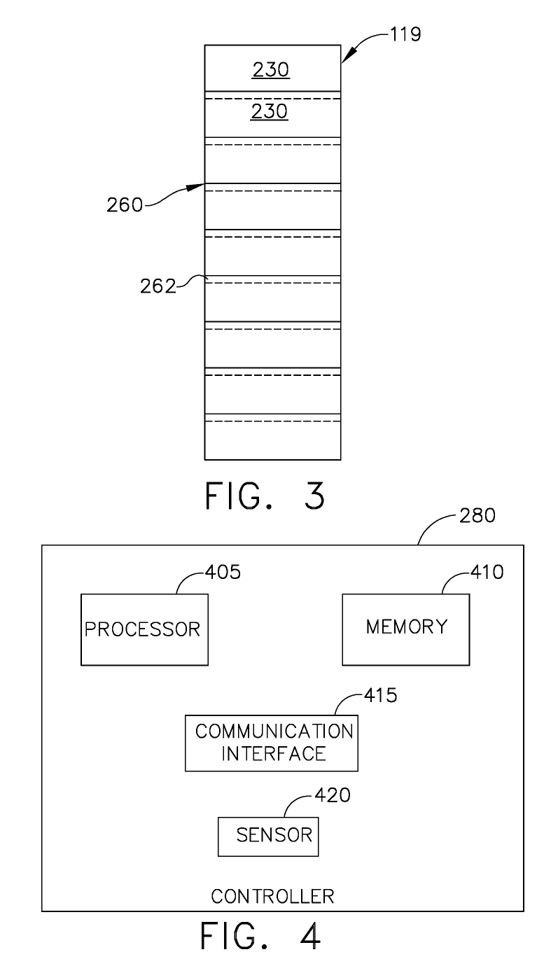

FIG. 2 is a view 200 of a cross-section of high-pressure (HP) compressor 124 (shown in FIG. 1) including a rotor assembly 202 and a stator assembly 204 as well as actuated shroud system 180 (shown in FIG. 1). FIG. 3 is a view 300 of shroud 119 at least partially surrounding rotor assembly 202. Rotor assembly 202 includes rotor 210 and rotor disk 212. A plurality of blade members (“blades”) 214 (shown in FIG. 1) is coupled to rotor disk 212. Each blade 214 includes an airfoil 216 and a blade tip 218, and each blade tip 218 defines an outer blade tip surface 220. In the illustrated embodiment, tip outer surfaces 220 are angled in a radial direction. In alternative embodiments, tip outer surface 220 may be substantially planar or flat, without an angle, or may feature an alternative shape (e.g., a concave or convex curve or more complex shape). Stator assembly 204 includes a stator vane 215.

In the illustrated embodiment, shroud 119 includes at least one shroud segment 230. As described further herein, in embodiments in which shroud 119 includes two or more shroud segments 230, shroud 119 further includes a segment seal assembly 260. Shroud 119 includes a radially inner surface 232, which, in the illustrated embodiment, is angled complementarily to tip outer surface 220. A tip clearance gap 234 is defined between shroud inner surface 232 and tip outer surface 220. As described herein, minimizing tip clearance gap 234 while maintaining a predetermined threshold distance between shroud inner surface 232 and tip outer surface 220 is desirable. The predetermined threshold distance is a tip clearance gap 234 chosen to increase or optimize performance of HP compressor 124. The predetermined threshold distance may vary depending on the size, shape, and/or configuration of blade members 214 and/or shroud 119. In one embodiment, the predetermined threshold distance is determined by calculating the “worst-case” condition for rapid changes in throttle. For instance, a tip radius of blade member 214 is calculated at low throttle, and then calculated again assuming a large increase in throttle. Varying thermal expansion characteristics for each material of rotor assembly 202 are taken into account, as well as the size and length of each component thereof. A difference between low throttle tip radius and high throttle tip radius is calculated and set as the predetermined threshold distance, or minimized tip clearance gap 234.

During operation of turbofan engine 100, particularly during take-off or other high-throttle conditions, tip outer surface 220 may shift towards shroud 119 due to thermal expansion of blade members 214. Shroud 119 must be maintained at least at the predetermined threshold distance away from blade tip 218. However, under other conditions, such as cruise, blade members 214 may contract to a shorter length. If shroud 119 were maintained in the same position, tip clearance gap 234 would increase, reducing the efficiency of HP compressor 124.

Accordingly, in the example embodiment, actuated shroud system 180 is configured to vary a position of shroud 119 to maintain tip clearance gap 234 at about the predetermined threshold distance, or a “minimized” distance. In particular, actuated shroud system 180 is configured to perform substantially instantaneous control of the position of shroud 119. It should be understood that although “minimized” may be used herein, tip clearance gap 234 may be maintained at any particular dimension to improve performance of HP compressor 124.

In the example embodiment, actuated shroud system 180 includes a shroud actuator 238. More particularly, shroud actuator 238 includes a plurality of cams 240, each cam 240 disposed radially outwardly from a corresponding blade member 214, a lever mechanism 242 mechanically coupled to each cam 240, and a unison bar 244 coupling one or more of the plurality of cams 240 together for simultaneous movement thereof. Upon movement of unison bar 244, cams 240 rotate. The rotational motion of cams 240 is translated into linear movement of lever mechanisms 242. Each lever mechanism 242 is mechanically coupled to shroud 119, such that movement of a lever mechanism 242 controls translation of a corresponding shroud segment 230. Moreover, in the illustrated embodiment, each cam 240 is mechanically coupled to shroud 119 by a spring 274, which is pre-tensioned to a predetermined amount to pull a corresponding shroud segment 230 in axial direction A. Accordingly, shroud 230 is in constant contact with corresponding cam 240. When cam 240 is rotated, shroud segment 230 is shifted in according with the outer radius (not shown) of cam 240. Cam 240 may have an elliptical or asymmetrical shape or may have a circular shape with an off-center cam shaft 241 therethrough. It should be understood that in certain embodiments, actuated shroud system 180 may not include a unison bar 244, such that each cam 240 and, therefore, lever mechanism 242 may be independently controlled.

To facilitate translation of shroud 119, a rail 246 and pin 248 system is coupled to shroud 119 and shroud actuator 238. In the illustrated embodiment, rail 246 is coupled to a radially outer surface 221 of shroud 119, and pin 248 is coupled to shroud actuator 238 (and/or a frame 250 of HP compressor 124). Accordingly, when lever mechanism 242 actuates movement of shroud 119, shroud 119 is translated according to a path 252 of rail 246. Rail 246 can define any path 252, including straight lines, curves, complex curves, one-dimensional (e.g., radial or axial) paths, two-dimensional paths (e.g., radial and axial), and/or any combination thereof. Path 252 is designed such that shroud segment 230 is translated with respect to blade tip 218 to vary tip clearance gap 234 by pin 248 travelling through path 252 of rail 246. For example, due to the radial angle of outer tip surface 220 and inner shroud surface 232, path 252 may include an axial path such that shroud actuator 238 translates shroud 119 axially to vary tip clearance gap 234.

In certain embodiments, path 252 includes a radial or radial and axial path, such that shroud 119 includes two or more circumferentially adjacent shroud segments 230. Shroud 119 also includes, in such embodiments, a segment seal assembly 260 (see FIG. 3) configured to maintain a seal between circumferentially adjacent shroud segments 230 throughout radial movement of shroud segments 230. Segment seal assembly 260 may include any sealing mechanism suitable to maintain a seal between shroud segments 230. In one embodiment, segment seal assembly 260 includes a lap joint 262 between adjacent shroud segments 230. In other embodiments, segment seal assembly 260 may include a membrane seal, labyrinth seal, bellows-type seal, and/or any suitable sealing mechanism.

In addition, in certain embodiments, a vane seal assembly 270 is associated with shroud 119 and stator vane 215. More particularly, vane seal assembly 270 is coupled between shroud 119 and stator vane 215 to maintain a seal therebetween. Vane seal assembly 270 is configured to maintain such a seal upon a predetermined amount of axial and/or radial movement of shroud 119. Vane seal assembly 270 may include any sealing mechanism suitable to maintain a seal between shroud 119 and stator vane 215. In one embodiment, vane seal assembly 270 includes a piston ring 272. In other embodiments, vane seal assembly 270 may include a membrane seal, labyrinth seal, bellows-type seal, lap joint, and/or any suitable sealing mechanism.

Actuated shroud system 180 further includes a controller 280. Although controller 280 is shown as being located radially outward from shroud 119, it should be understood that controller 280 may be located at any suitable position, including in a position outside of HP compressor 124. Controller 280 is configured to control one or more component of actuated shroud system 180, in particular, shroud actuator 238. In the example embodiment, controller 280 facilitates substantially instantaneous control of shroud actuator 238, such that the position of shroud 119 is substantially instantaneously varied. Accordingly, the need for bleed air cooling systems in the vicinity of blade tips 218 is reduced or eliminated, and more efficient tip clearance gap 234 control is effected. Moreover, tip clearance gap 234 can be minimized throughout the duration of a flight, even during rapid throttle changes, improving HP compressor 124 and engine 100 efficiency. As used herein “instantaneous” or “real-time” refers outcomes occurring at a substantially short period after an input. The time period is a result of the capability of controller 280 implementing processing of inputs to generate an outcome. Events occurring instantaneously occur without substantial intentional delay.

FIG. 4 is a schematic block diagram of an example embodiment of controller 280 (shown in FIG. 2) of actuated shroud system 180 (shown in FIGS. 1 and 2). Controller 280 includes a processor 405 for executing instructions. Instructions may be stored in a memory area 410, for example. Processor 405 may include one or more processing units (e.g., in a multi-core configuration) for executing instructions. The instructions may be executed within a variety of different operating systems on controller 280. Processor 405 is configured to execute the processes described herein for controlling various components of actuated shroud system 180.

Processor 405 is operatively coupled to a communication interface 415 such that controller 280 is capable of communicating with a remote device such as a one or more aircraft control systems (not shown) and/or sensing or measuring components. Communication interface 415 may include, for example, a wired or wireless network adapter or a wireless data transceiver for use with a network. For example, communication interface 415 be in wired or wireless communication with an aircraft control system and may receive signals (e.g., requests or instructions) therefrom to control shroud actuator 238. In certain embodiments, processor 405 transmits control signals to vary the position of shroud 119 substantially instantaneously based on throttle-level of fuel flow signals. In other words, upon receiving a signal from another aircraft control signal that throttle and/or fuel flow to core engine 116 (shown in FIG. 1) is increasing, controller 280 may transmit appropriate control signals to translate shroud 119 in order to increase tip clearance gap 234.

Memory area 410 is any device allowing information such as executable instructions and/or other data to be stored and retrieved. Memory area 410 may include one or more computer-readable media. Memory area 410 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Controller 280 may further include one or more sensors 420, which are configured to measure one or more parameters at or around shroud 119. For example, sensor 420 may measure temperature of shroud 119 and/or blade tip 218, and/or sensor 420 may measure a current tip clearance gap 234 (i.e., a distance between inner shroud surface 232 and outer tip surface 220). Sensor 420 generates an output signal that may be used by processor 405 to actuate shroud actuator 238 (e.g., in an active feedback loop or according to particular threshold values).

The above-described actuated shroud systems provide an efficient method for minimizing a tip clearance gap. Specifically, the above-described actuated shroud system includes a cam and lever system configured to translate at least a portion of the shroud axially and/or radially to vary the tip clearance gap according to engine conditions. During low-throttle conditions such as cruise, the tip clearance gap may be reduced to a predetermined threshold distance, which improves engine efficiency over engines having a static shroud (with a non-variable tip clearance gap), facilitating more efficient, lighter engine designs.

Exemplary embodiments of actuated shroud systems are described above in detail. The actuated shroud systems, and methods of operating such systems and component devices are not limited to the specific embodiments described herein, but rather, components of the systems and/or steps of the methods may be utilized independently and separately from other components and/or steps described herein. For example, the actuated shroud systems may be used in any rotating systems (e.g., high-pressure turbine, low-pressure turbines, intermediate-pressure turbines, power turbines, fans, compressors, etc.), and should be not construed to be limited to aircraft turbofan engines.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An actuated shroud system configured to control tip clearances in a rotatable machine having blade members with a tip angled in a radial direction, said system comprising:
a rotor comprising a plurality of blade members extending radially outwardly from a rotor disk, each blade member of said plurality of blade members comprising a blade tip at a radially outer extent of said blade member, each said blade tip comprising a radially outer tip surface angled in the radial direction;
a shroud circumscribing said plurality of blade members and comprising a radially inner surface angled complementarily to said radially outer tip surface of said plurality of blade members, said radially inner surface and said radially outer tip surface defining a tip clearance gap therebetween; and
a shroud actuator operably coupled to said shroud, said shroud actuator configured to translate said shroud in at least one of an axial direction and the radial direction such that the tip clearance gap is variable based on a position of said shroud actuator.

2. The system of claim 1, further comprising a tip clearance controller communicatively coupled to said shroud actuator.

3. The system of claim 1, wherein said shroud actuator comprises a lever mechanism configured to control the translation of said shroud.

4. The system of claim 1, wherein said shroud actuator comprises a cam mechanism configured to control a radial movement of said shroud.

5. The system of claim 1, wherein said shroud is formed of a plurality of circumferential segments, each segment sealed to a circumferentially adjacent segment using a segment seal assembly.

6. The system of claim 5, wherein said segment seal assembly comprises a lap joint.

7. The system of claim 1, further comprising a vane seal assembly positioned between said shroud and a stator vane to maintain a closed seal while permitting a predetermined amount of radial movement.

8. The system of claim 7, further comprising a piston ring incorporated in said vane seal assembly.

9. A method of varying a tip clearance gap using an actuated shroud, said method comprising:
operably coupling a shroud actuator to a shroud that circumscribes a plurality of blade members of a rotor, wherein each blade member of the plurality of blade members includes a blade tip at a radially outer extent of the blade member, each of the blade tips includes a radially outer tip surface angled in the radial direction, and the shroud includes a radially inner surface angled complementarily to the radially outer tip surface of the plurality of blade members, the radially inner surface and the radially outer tip surface defining a tip clearance gap therebetween; and
varying a position of the shroud actuator, said varying translating the shroud in at least one of an axial direction and the radial direction such that the tip clearance gap is variable based on a position of the shroud actuator.

10. The method of claim 9, further comprising coupling a tip clearance controller in communication with the shroud actuator.

11. The method of claim 9, wherein operably coupling the shroud actuator to the shroud comprises mechanically coupling a lever mechanism and a cam mechanism to the shroud, wherein the lever mechanism and the cam mechanism are configured to control a radial movement of the shroud.

12. The method of claim 9, wherein the shroud includes a plurality of circumferential segments, said method further comprising associating a segment seal assembly with the plurality of circumferential segments to maintain a seal between adjacent circumferential segments, wherein the segment seal includes a lap joint between adjacent circumferential segments.

13. The method of claim 9, further comprising associating a vane seal assembly with the shroud and a stator vane proximate the rotor to maintain a closed seal between the shroud and the stator vane.

14. The method of claim 9, wherein associating a vane seal assembly with the shroud and a stator vane comprises coupling a piston ring between the shroud and the stator vane.

15. A turbofan engine comprising:
a core engine including a multistage compressor;
a fan powered by a power turbine driven by gas generated in said core engine;
a fan bypass duct at least partially surrounding said core engine and said fan; and
an actuated shroud system configured to control tip clearances in said compressor, said actuated shroud system comprising:
a rotor comprising a plurality of blade members extending radially outwardly from a rotor disk, each blade member of said plurality of blade members comprising a blade tip at a radially outer extent of said blade member, each said blade tip comprising a radially outer tip surface angled in the radial direction;
a shroud circumscribing said plurality of blade members and comprising a radially inner surface angled complementarily to said radially outer tip surface of said plurality of blade members, said radially inner surface and said radially outer tip surface defining a tip clearance gap therebetween; and
a shroud actuator operably coupled to said shroud, said shroud actuator configured to translate said shroud in at least one of an axial direction and the radial direction such that the tip clearance gap is variable based on a position of said shroud actuator.

16. The turbofan engine of claim 15, said actuated shroud system further comprising a tip clearance controller communicatively coupled to said shroud actuator.

17. The turbofan engine of claim 15, wherein said shroud actuator comprises a lever mechanism configured to control the translation of said shroud.

18. The turbofan engine of claim 15, wherein said shroud actuator comprises a lever mechanism configured to control the translation of said shroud.

19. The turbofan engine of claim 15, wherein said shroud is formed of a plurality of circumferential segments, each segment sealed to a circumferentially adjacent segment using a segment seal assembly, said segment seal assembly comprising a lap joint.

20. The turbofan engine of claim 15, said actuated shroud system further comprising a vane seal assembly positioned between said shroud and a stator vane to maintain a closed seal while permitting a predetermined amount of radial movement, said vane seal assembly comprising a piston ring.
